(19) United States
(12) Patent Application Publication
(10) Pub. No.: US 2013/0046583 A1
(43) Pub. Date: Feb. 21, 2013

(54) METHOD AND SYSTEM FOR ENTERPRISE AUDIT

(71) Applicants: SANDHYA KANHED, Weikfield IT City (IN); Deepa Rajeev, Mumbai (IN)

(72) Inventors: SANDHYA KANHED, Weikfield IT City (IN); Deepa Rajeev, Mumbai (IN)

(21) Appl. No.: 13/212,181

(22) Filed: Aug. 18, 2011

(51) Int. Cl. G06Q 10/06

(52) U.S. Cl. 705/7.36

(57) ABSTRACT

Embodiments of the present invention are directed to a method and system for auditing an enterprise that involves creating an Internal Audit Plan. The method is to define the scope of such Internal Audit engagement under the Audit Plan Workflow and create Process Notes that detail out processes followed during an audit engagement. A Verifying Evidence module records all test templates by users and process owners and a final report is generated for Internal and External Audit Engagements. The system is capable of seeing management response and also implements the status of Internal and External Audit engagements on due dates with appropriate reminders. In this manner the present invention increases transparency, reduces time & efforts associated with accessing the audit information.

### FIELD OF THE INVENTION

The invention broadly falls under the technical field of Computer Applications and more particularly in the area of automating auditing functions in an organization.

### DESCRIPTION OF THE RELATED ART

As modern day organizations grow bigger, diverse and complex, there arises need to manage systematically its operations. An audit helps an organization accomplish its objectives by bringing a systematic, disciplined approach to evaluate and improve the effectiveness of risk management, control, and governance processes.

Internal auditing scope is increasing in modern day organizations. Broadly the process involves examination of and recommending on any internal processes of an organization. In its advisory role, the Internal Auditing process has special attention from senior executives and boards. With commitment to integrity and accountability, internal auditing provides value to governing bodies and senior management as an objective source of independent advice. Failure of Internal Audit processes may lead to an organization being prone to frauds, inefficiency and incompetency.

Not only the Internal Auditing processes are a necessity, but are also obligatory in nature. Various Corporate Governance statutes like Sarbanes Oxley Act make it obligatory for Internal Auditor team to work closely with several departments of an organization.

The scope of internal auditing within an organization is broad and may involve topics such as the efficacy of operations, the reliability of financial reporting, deterring and investigating fraud, safeguarding Intellectual Property, and compliance with laws and regulations. It is truly multi-disciplinary and multi-functional process that involves interactions with several departments of organization. Highly qualified professionals are engaged to check on the processes and give recommendations.

With the kind of importance, diversity and complexity attached to an Auditing process, organizations have always strived to have tools to manage and co-ordinate processes. They are more willing to invest in making Auditing processes run smoothly without causing major diversions from main business. Some of the previous efforts in this direction are discussed as under.

U.S. Pat. No. 7,523,053 is titled Internal Audit Operations for Sarbanes Oxley Compliance. This patent provides audit opinions on an enterprise's organization processes, risks and risk controls. The novelty part resides in method performed by a computer program to produce audit opinion for each risk and business processes.

U.S. Pat. No. 7,899,693 is titled Audit management workbench. This patent provides for an audit manager that can create an audit project from an audit project template derived from the business processes, the risks, and the risk controls. In this manner an audit manager can effectively display the associations between the business processes, the risks, and the risk controls.

U.S. Pat. No. 7,756,762 is titled Method, system, and computer readable medium for providing audit support. The invention is a method to provide an audit support including displaying sample letter images, where each of the sample letter images is associated with one of a number of audit categories.

U.S. Pat. No. 7,072,895 is titled Audit System and Method. The invention provides a system and method for reducing and potentially eliminating the review of source documents by auditors to determine whether there is compliance of an audited subject area with a predetermined set of rules.

Number of audit tools are available in the market that reduce time, cost or increase efficiency of doing internal audits in organization. MKInsight audit management tools on its website mentions very attractive feature including Role based Privileges to customize Audit planning. TeamMate's award-winning system is designed to increase the efficiency and productivity of the entire internal audit process, including: risk assessment, scheduling, planning, execution, review, report generation, trend analysis, committee reporting and storage. eRiskScorecard is a web-based risk management software, developed by Wiltshire Consulting Inc., that simplifies and facilitates the assessment, communication and reporting of risks. Accessible worldwide from any Internet web-browser, you can use eRiskScorecard to plan an upcoming risk assessment, conduct on-line, real time risk assessments with key remote participants and create both detailed and summary reports. MetricStream Audit Management software module is a comprehensive audit system designed to help companies manage a wide range of audit-related activities, data and processes. Advanced capabilities like built-in remediation workflows, time tracking, emails based notifications and alerts, risk assessment methodologies, and offline functionality for conducting at remote field sites allow organizations to implement the industry best practices for efficient audit execution and ensure integration of the audit process with the risk and compliance management system.

Modern day organizations are highly dynamic and there is newer requirement of features that are flexible and may change at every stage of audit processes. For example, selecting the process owners at every stage in the total process still remains a challenge in the prior art discussed. Thus, a need exists to make an audit tool flexible and scalable to fit in the needs of modern day corporations.

### SUMMARY OF THE INVENTION

Accordingly, embodiments of the present invention provide systems and methods for making an audit tool flexible and scalable to fit in the needs of modern day corporations.

In one embodiment, the present invention allows modification of Internal Audit plan even post approval.

In another embodiment, the present invention allows facility to choose the intended recipients at every stage in audit. The method includes different process owners can be chosen every stage—audit scope, reporting, etc.

In yet another embodiment, the present invention provides for facility to customize the test templates, Risk register for every audit engagement.

In yet another embodiment, the present invention provides for facility to create Annexure-automated through uploaded test templates and manual upload.

In yet another embodiment, the present invention provides for facility to perform multiple task assignments for one observation and automated section for responses from process owners (including the approval from audit team) and the to-and-fro data flow therein for all the updates for management response and updated status of the audit issues.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 shows a flow chart of Internal Audit Workflow, in accordance with one embodiment of the present invention.

FIG. 2 shows a flow chart of Audit Plan and Scope Workflow.

FIG. 3 shows a flow chart of Process Notes Workflow in accordance with one embodiment of the present invention.

FIG. 4 is flow chart for Evidence Verified Workflow.

FIG. 5 shows an exemplary flowchart of Final Audit Report Workflow for Internal Audit Engagement.

FIG. 6 shows the Annexure creation with uploaded Test template.

FIG. 7 shows the Annexure creation with any other data, than in the test templates for Annexure.

FIG. 8 shows an exemplary flowchart of Final Audit Workflow for External Audit Engagement.

FIG. 9 shows Management Response Workflow for Internal Audit Engagement.

FIG. 10 is implementation status Workflow for Internal Audit Engagement.

FIG. 11 is Management Response Workflow for External Audit Engagement.

FIG. 12 is implementation status for External Audit Engagement.

FIG. 13 is a flowchart depicting Pool Mails for response pending from Primary Respondent.

FIG. 14 is reminder Pools mails for response pending from secondary Respondent.

FIG. 15 is flowchart depicting escalation Mails for pending implementation status.

FIG. 16 is flowchart depicting escalator's comments on audit observations.

### DETAILED DESCRIPTION

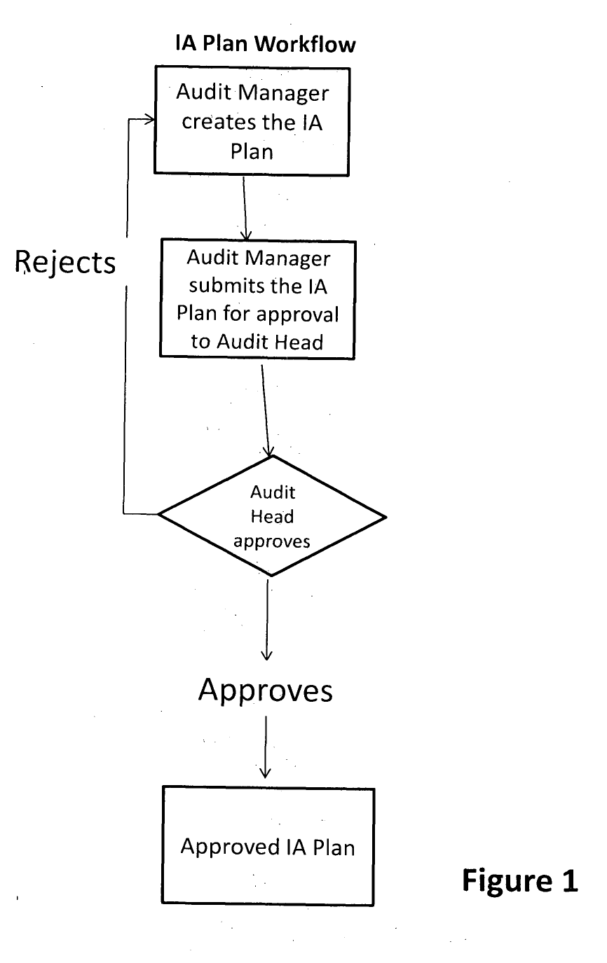

FIG. 1 is a block diagram of a system 100 for proactively monitoring application health data to achieve workload management and high availability according to various embodiments. The system 100 comprises a server 102 and a node 104 where each is coupled to each other through a network 106. It is appreciated that the system 100 comprises a plurality of nodes that provides application services to one or more client computers. Alternatively, the system 100 may include a peer-to-peer cluster.

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications, and equivalents, which may be included within the scope of the invention as construed according to the appended Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “deactivating,” “disabling,” “freezing,” “re-activating,” “enabling,” “thawing,” “sending,” “determining,” “flushing,” “responding,” “generating,” “making,” “blocking,” “accessing,” “taking a snapshot,” “associating,” “allowing,” “updating,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices.

Exemplary Operating Environment

The present invention has purpose-built audit components that increases transparency and reduces time and effort associated with accessing the audit information. This system provides access to the audit plan, reports and audit issues.

There is approval workflows incorporated at various stages for the following areas, i.e. IA Plan; Audit Plan & Scope; Process Notes; Evidence Verified; Final Audit Report (Internal & External Auditors); Management Response (Internal & External Auditors); Implementation Status (Internal & External Auditors).

Further, Reminder Pool mails are implemented in the following scenarios 1) Response pending from Primary Respondent; 2) Response pending from Secondary Respondent; 3) Escalation mails for Implementation Status.

FIG. 1 shows a flow chart of Internal Audit Workflow, in accordance with the embodiment of the present invention. This module will be used by the Audit Managers in the system to create an IA Plan (Internal Audit Plan) in the system. Once the plan is created the Audit Manager can submit the IA Plan for approval from Audit Head via the View IA Plan interface. For example, for a particular financial year (2010-2011) and a particular entity (say, WNS India), the scope for certain processes could be FS and the scope for other processes could be LR. However, 1 process (e.g. Transport) cannot have the scope of FS and LR both. The created Internal Audit plan can be deactivated, if required.

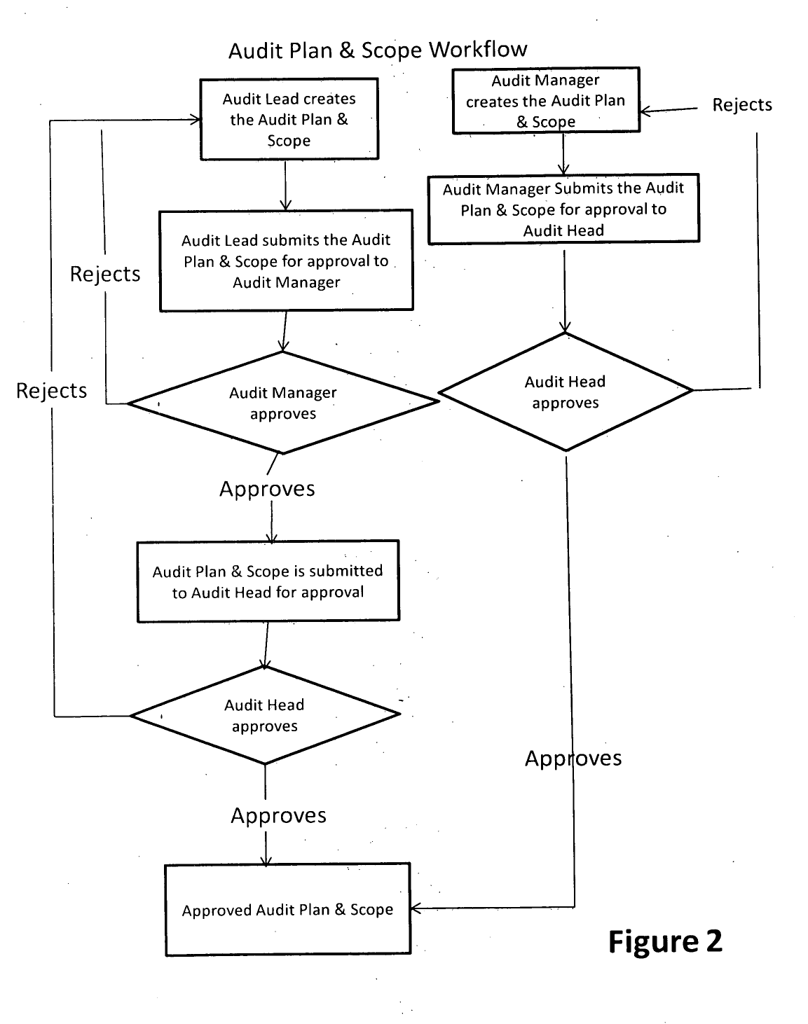

FIG. 2 shows a flow chart of Audit Plan and Scope Workflow. This module will be used by the Audit Lead and Audit Manager to define the plan and scope of the audit engagement. The plan and scope thus defined will be sent out to process owners as a PDF document (external to the system). The scope will also form part of the final audit report. The person assigned as Audit Head cannot be given any other role for an audit engagement. The Audit Lead and Audit Staff can be the same person for an audit engagement

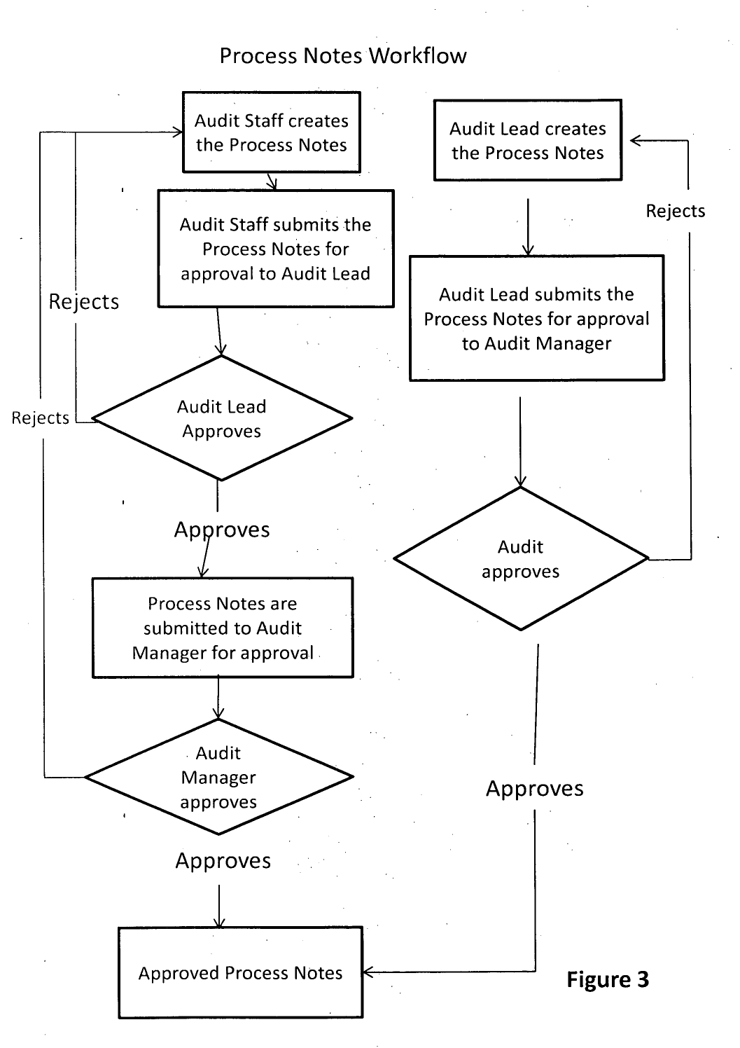

FIG. 3 shows a flow chart of Process Notes Workflow in accordance with one embodiment of the present invention. This module will be used by the audit staff or audit lead to enter the process notes for the processes of an audit engagement. A facility to upload files (for example: flowcharts in PDF format etc) as part of the process notes is also provided. Only used by audit-lead and audit manager to enter data and audit staff and audit head will have read only access. The user can enter many process notes & each process note will have many uploaded files associated with it. The system allows this section to be marked as complete only after it has been approved by the final approver. The user is able to view the approval workflow history and current approval workflow status of the Process Notes.

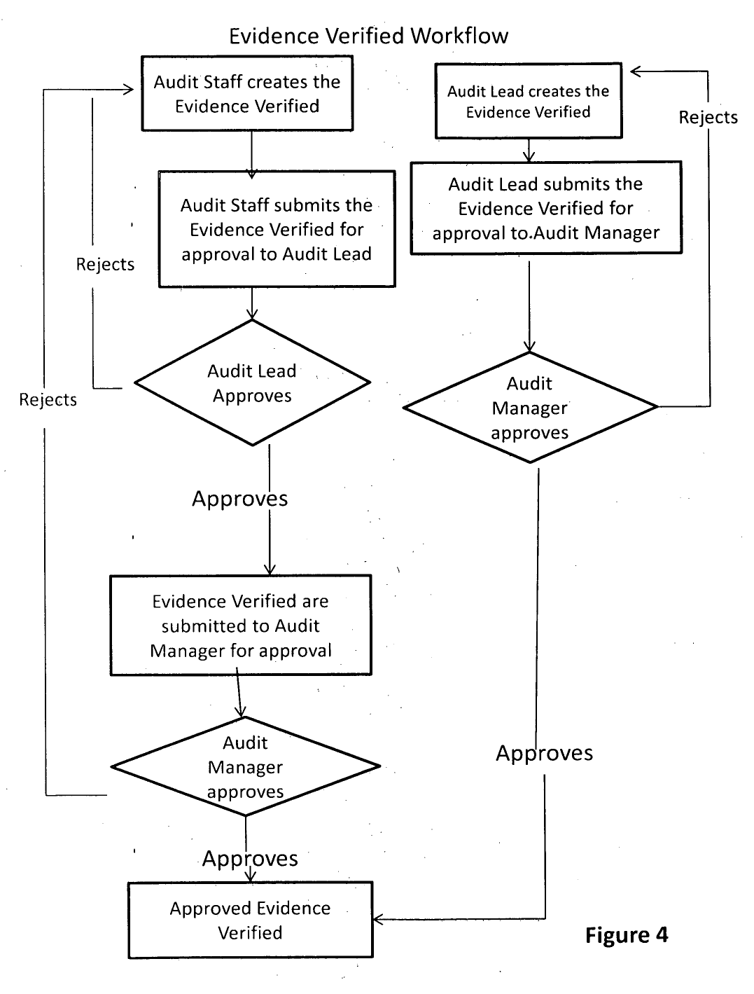

FIG. 4 is flow chart for Evidence Verified Workflow. This module is used by the audit staff or audit lead to enter the download fieldwork templates, upload filled in templates and editing uploaded data. The user is able to fill in the test template in an offline mode (when not connected to the network). After the user is back on the network, the user is able to synchronize the data. The test template is downloaded empty by the Audit Lead and Audit Staff. They can fill and upload the same. The user is able to view the approval workflow history and current approval workflow status.

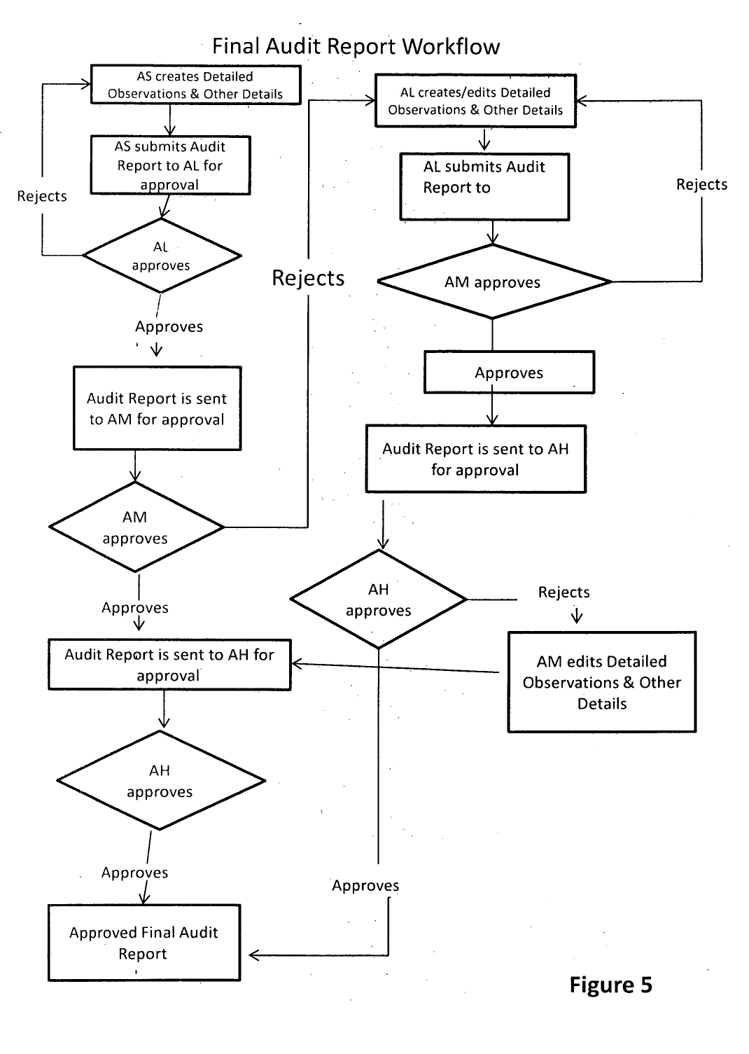

FIG. 5 shows a flowchart of Final Audit Report Workflow for Internal Audit Engagement. This module is used by the audit lead or audit manager to generate the final audit report for the audit engagement. The reports generated carry a word as ‘Draft’ for those reports which are not approved yet. The name is used as a watermark in the document background. The Report once approved by AH generates a document which would be tagged as “Final” in the final version and is circulated to all those concerned. There is an upload option wherein the user can upload formatted report document in either PDF or PPT format.

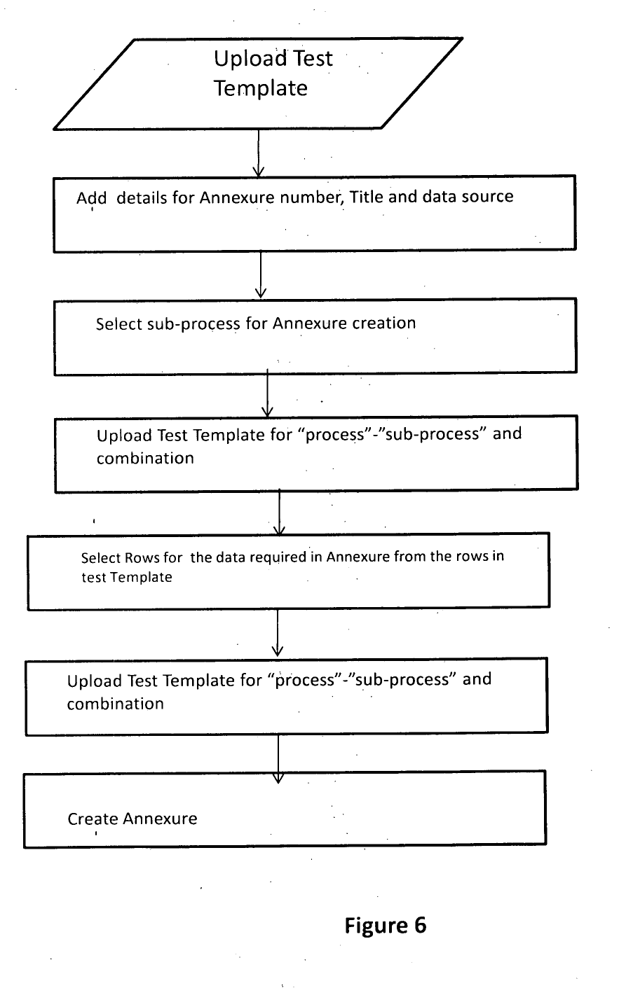

FIG. 6 shows the Annexure creation with uploaded Test template. The Test Template for the selected combination of the ‘Process and Sub-process’ is uploaded onto Auditpro. During the Annexure Creation phase, we start by clicking on ‘Create Annexure’. We need to enter the details for the Annexure number, the title of the Annexure and the source of the data contained in Annexure. We can also re-order the Annexure after we number the Annexure. We then select the combination of the ‘sub-process’ for which we need to create the Annexure; then the respective test template is called for from the test template uploaded for the selected combination. We then select those column headings from all the column headings in the Test template from which we shall require the data in the Annexure. Then all the rows will be displayed for the selected column headings, from which we can select the rows that are required for the creation of the Annexure. On selection of the rows, once we click on ‘Create Annexure’, the Annexure is created for the selected data from the Test template.

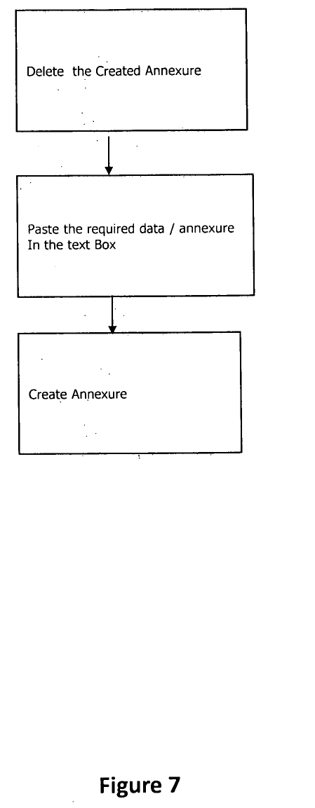

FIG. 7 shows the Annexure creation with any other data, than in the test templates for Annexure. We can delete the created Annexure and just paste the required Annexure in the text box therein, to create a ‘Custom’ Annexure.

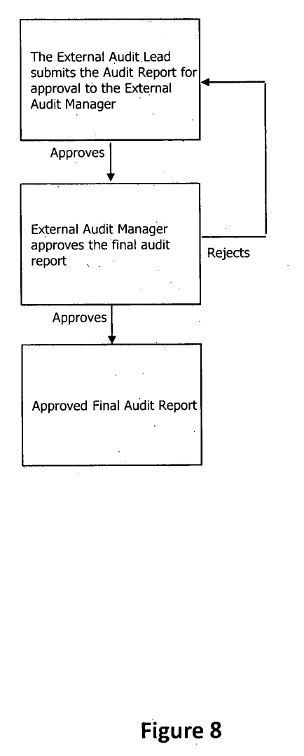

FIG. 8 shows an exemplary flowchart of Final Audit Workflow for External Audit Engagement. This module will be used by the External auditors. The external auditor would be another role in the system which would be assigned via the User Master. The Role would be known as ‘External Auditor’. The External Auditor users will have access to the following sections in the application IA Plan—View IA Plan, Audit Engagements—Reporting Section, Notifications—Management Response, Issue Tracker, and Final Audit Report. All Reports that are available to Internal Audit Team—feedback report not accessible.

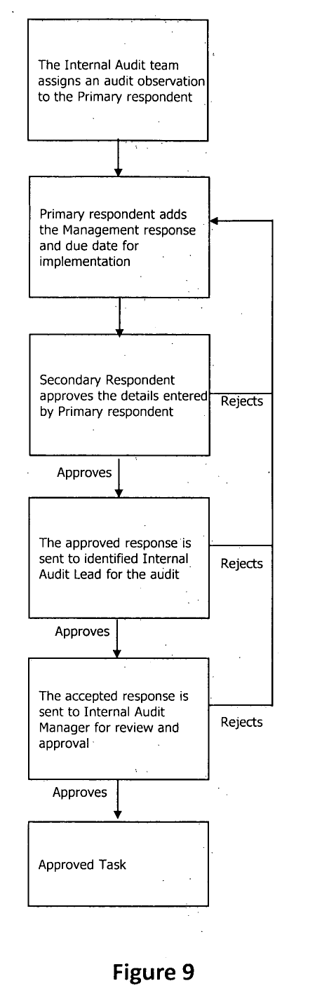

FIG. 9 shows Management Response Workflow for Internal Audit Engagement. This module will be used by the Audit Lead or Audit Manager to input the details of the observations for the Audit Engagement in the system. It will also allow the AL or AM to add tasks and assign them to primary respondents. The Internal Audit Team assigns an observation to the Primary Respondent. A task (management response) is defined, respondents and an implementation due date is assigned to a primary respondent to every observation. One detailed observation can have many tasks associated with it. The PR, SR, E1, E2 selected in the drop downs are Sr. Managerial positions only. On the page for the addition of the users, irrespective of the designation we need to choose among the options for ‘Sr. Manager’ and ‘SVP and above’. When the details of these lists are filled, a task pertaining to that observation is assigned. After the detailed observations (and tasks) and annexure have been approved by the Audit Head for the 1st time, edits if any to the detailed observations or tasks can be done only by the audit manager. The primary respondent cannot change the management response and due date for implementation, once it has been approved by the audit manager.

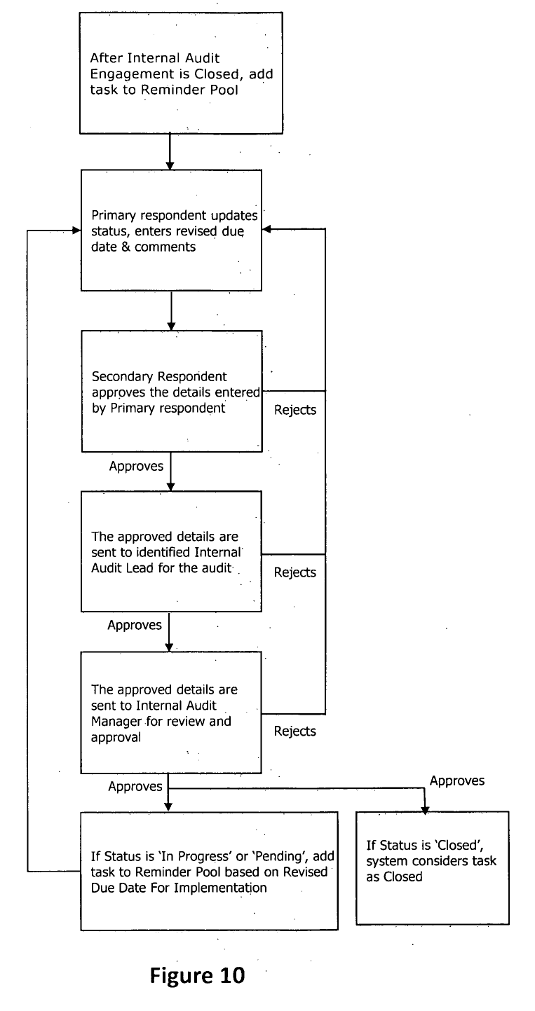

FIG. 10 is implementation status Workflow for Internal Audit Engagement. This module will be used by the Process Owners who are External to the Audit team to input the details of the observations for the Audit Engagement in the system. It will also allow them to add tasks and assign them to primary respondents. The Auditor assigns the tasks to the concerned Primary Respondent (“PR”); PR fills the management Response and DDFI (Due Date for Implementation) and forwards it to Secondary Respondent (SR) for approval. If the SR approves the response goes to the Audit Lead for approval and post Audit Leads's approval it will go for approval to Audit Manager. On approval by Audit Manager, it will become an approved response for the audit observation. On rejection by any of the approved roles it goes back to PR for modifications. Once the engagement is approved and closed, the approved MR would go into the Implementation status bucket. The flow would be PR->SR->AL->AM. The implementation workflow will go to the internal audit team. The Internal Audit Team Audit Manager can modify the PR, SR, E1, E2 set by the external audit team if required. At any stage, we can view the history of the rejections/approvals and comments.

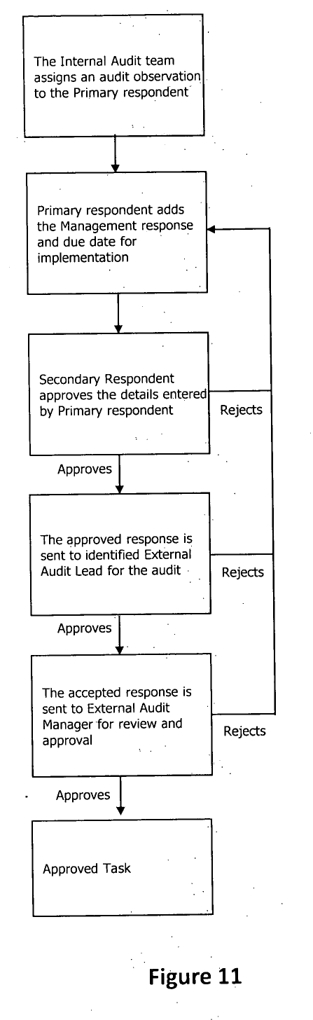

FIG. 11 is Management Response Workflow for External Audit Engagement. This module is used by the External Audit team to input the details of the observations for the Audit Engagement in the system. It will also allow them to add tasks and assign them to primary respondents. The observations and tasks can be added at any time by the external audit team and there is no approval workflow for starting the assignment of Task assignment. The external audit team can assign Task to any of the Primary Respondent assigned. The user should be able to view the approval workflow history and current approval workflow status of the final audit report and tasks (Management Responses). The Task Assignment Workflow has only three players External Audit Lead, External Audit Manager, PR, and SR. The flow would be PR->SR->EXT_AL->EXT_AM. Once the engagement is approved and closed the approved MR goes into the Implementation status bucket. The flow would be PR->SR->AL->AM. The implementation WF will go to the internal audit team.

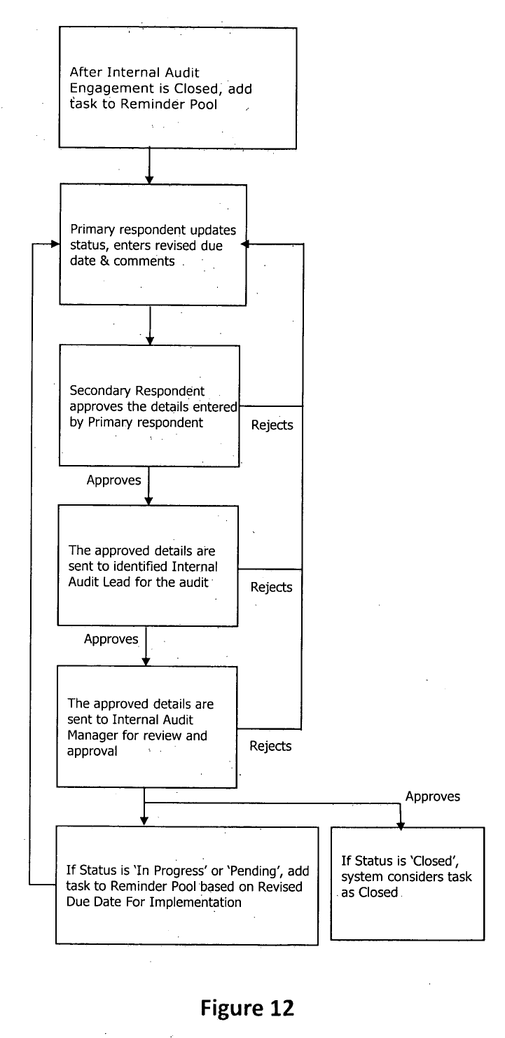

FIG. 12 is implementation status for External Audit Engagement. This module will be used by the External Audit team to input the details of the observations for the Audit Engagement in the system. It will also allow them to add tasks and assign them to primary respondents. The External Auditor assigns the tasks to the concerned PR; PR fills the management Response and DDFI and forwards it to SR for approval. If the SR approves the response goes to the External Auditor for approval and if the SR rejects it goes back to PR for modifications. If the External Auditor rejects it goes back to the PR for modifications. Once the engagement is approved and closed the approved MR would go into the Implementation status bucket. The flow would be PR->SR->AL->AM. The implementation WF will go to the internal audit team. The Internal Audit Team Audit Manager can modify the PR, SR, E1, E2 set by the external audit team if required.

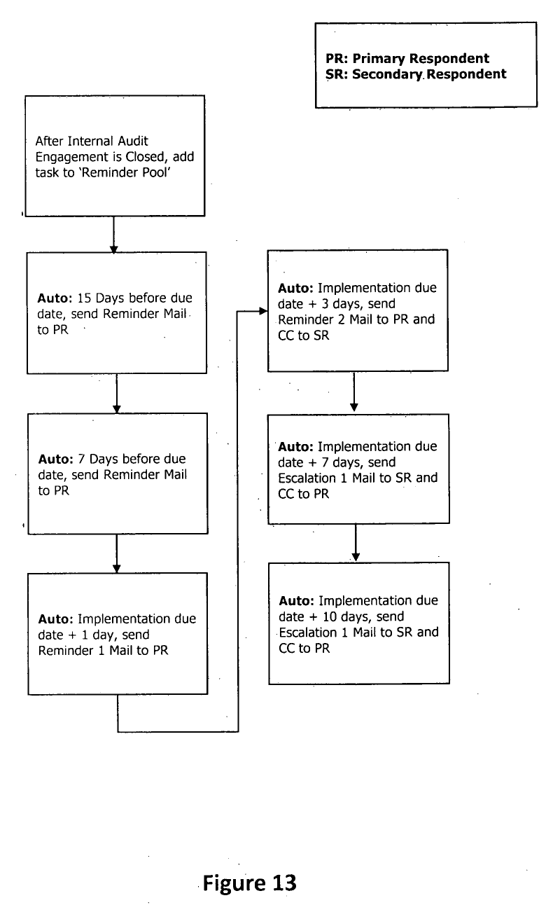

FIG. 13 is a flowchart depicting Pool Mails for response pending from Primary Respondent. There is email notifications sent to the respective users mapped in the application at various events in the application to provide management responses.

The example of such set of reminders can be as under:

1 15 days before approved DDFI or approved RDDFI and no response from PR
Send ‘Reminder 1’ mail to PR
7 days before approved DDFI or approved RDDFI and no response from PR
Send ‘Reminder 2’ mail to PR
On approved DDFI+1 day or approved RDDFI+1 day and no response from PR
Send ‘Alert 1’ mail to PR
3 days after approved DDFI+1 day or approved RDDFI+1 day and no response from PR
Send ‘Alert 2’ mail to PR with a copy marked to SR.
3 days after ‘Alert 2’ mail and no response from PR/SR
Send ‘Escalation 1’ mail to Escalator 1
3 days after ‘Escalation 1’ mail and no response from PR/SR
Send ‘Escalation 2’ mail to Escalator 2

The product feature can have configurable date and time settings for such reminders.

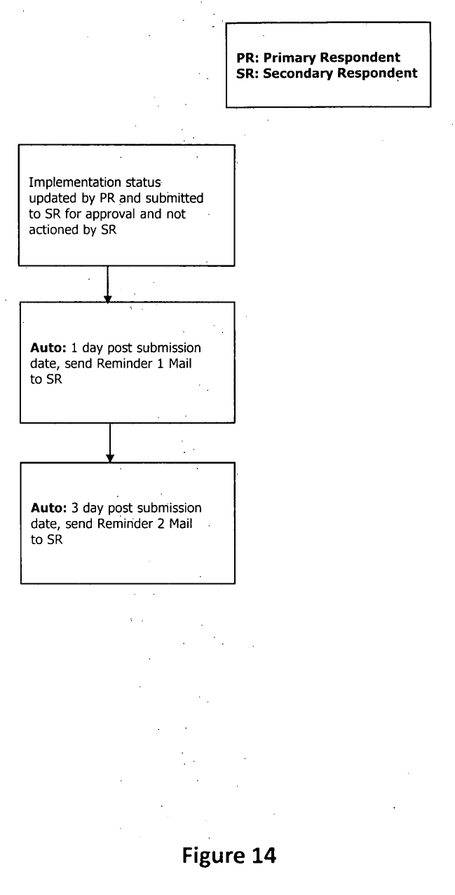

FIG. 14 is reminder Pools mails for response pending from secondary Respondent (SR). This module arises when implementation status is updated by PR and submitted to SR for approval and not auctioned by SR. The notifications are automatic, 1-day post submission and also 3-day post submission date.

As mentioned earlier, the product can have configurable date and time settings for such reminders to SR.

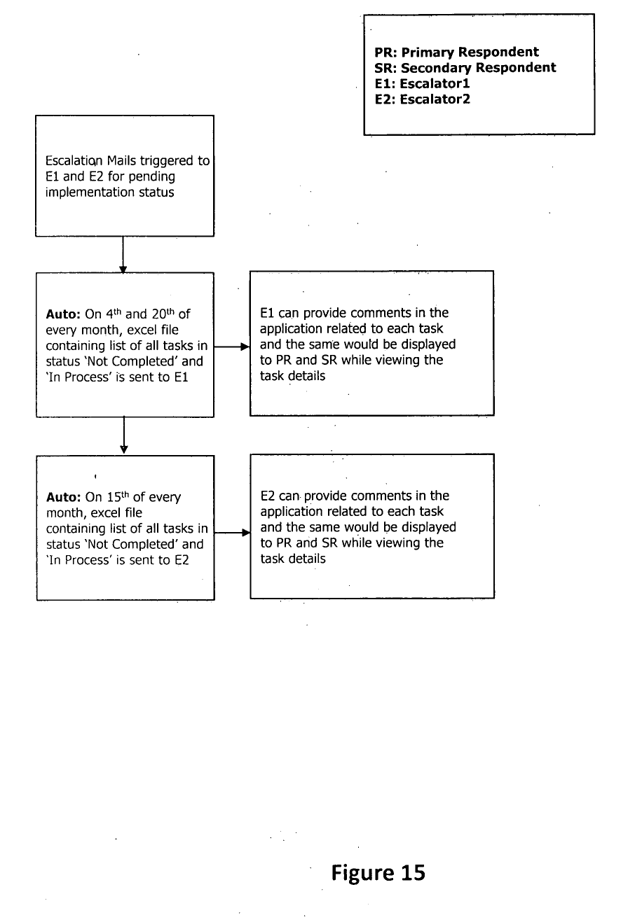

FIG. 15 is flowchart depicting escalation Mails for pending implementation status. A consolidated mail with an excel sheet [containing details of detailed observation and management response] as attachment is sent once a fortnight to the Escalator 1 and once a month to Escalator 2. The file details are as specified below of only those issues where they have been assigned as Escalator 1 and Escalator 2 respectively and where the system status of the task (Management Response) is not ‘Closed’. The excel file has the columns in the form of headers like the following:

Serial Number, Financial Year, Observation Title, Observation Details, Category, Management Response, Primary Respondent, Process Owners (Secondary Respondent, Escalator 1, Escalator 2), Due Date For Implementation, Revised Due Date For Implementation (if any) (approved by Audit.

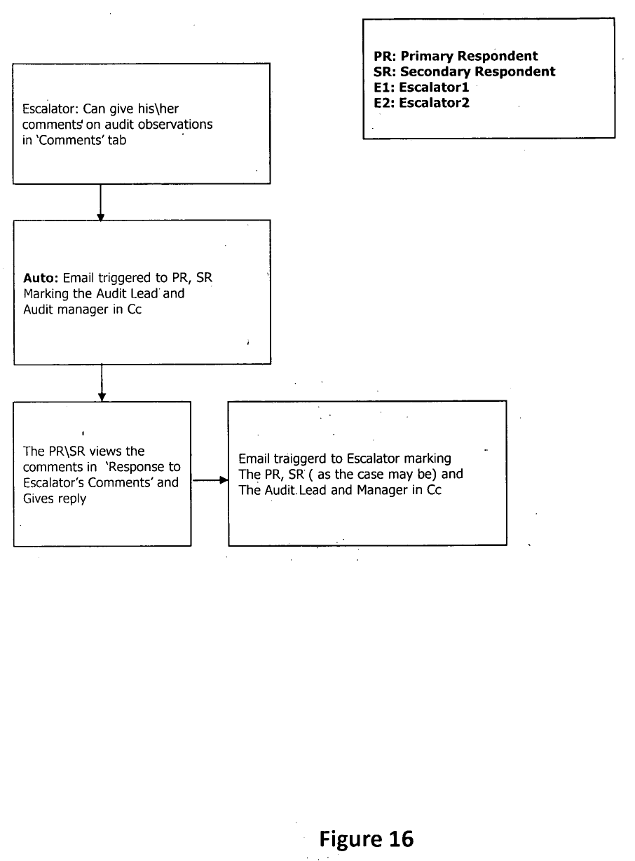

FIG. 16 shows the flowchart for escalator's comments on audit observations. An escalator can give further comments on audit observations in ‘Comments’ tab. This triggers an automatic email PR, SR and making audit lead and audit manager in the copy field. The PR, SR can view the comments in “Response to escalator's comments” and give reply accordingly.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

1. A method of implementing a Computer Application for auditing an enterprise, the method comprising:
creating an Internal Audit Plan Workflow;
defining the scope of such Internal Audit Plan under an Audit engagement, so as to send it out to process owners, such scope forming a part of the final audit report;
creating Process Notes that details out processes followed during an audit engagement, including ability to upload files and documents;
Verifying Evidence module to record all test templates by users and process owners;
Creating Annexure that record exceptions to the Test Templates;
Creating final reports for Internal and External Audit Engagement;
Seeking management response for the said Internal and External Audit Engagement; and
Implementing the status of Internal and External Audit engagement, as to increase transparency, reduce time & efforts associated with accessing the audit information.

2. A method of claim 1, wherein the said Computer Application can be implemented as part of a distributed computing environment, a cloud computing environment, a client server environment, etc.

3. The method of claim 1 wherein the said IA Plan can be modified till the initiation of an IA engagement.

4. The method of claim 1 wherein the said IA Plan can be deactivated at any given time.

5. The method of claim 1 wherein the said test templates are set of checklists that can be filled up online or offline.

6. The method of claim 1 wherein the said Annexure is uploaded with data from the Test Template.

7. The method of claim 1, wherein the said Annexure is uploaded with data available from any source other than Test template.

8. The method of claim 5 wherein the exceptions form the part of the test templates and are stored within the computer application itself.

9. The method of claim 1 wherein the process owners are added, deleted or changed at any stage in audit engagement.

10. The method of claim 1 that allows for approvals throughout the audit process at each stage.

11. The method of claim 10 that stores the history trail of audit process, including tracking of test template and annexure.

12. The method of claim 1 that allows integration of external auditors into the IA plan.

13. The method of claim 12 that allows external auditors to approve and comment on Audit engagement.

14. A computer readable storage medium having stored thereon, computer executable instructions that, if executed by a computer system cause the computer system to perform a method of providing storage information comprising:
creating an Internal Audit Plan Workflow;
defining the scope of such Internal Audit Plan under an Audit engagement, so as to send it out to process owners, such scope forming a part of the final audit report;
creating Process Notes that details out processes followed during an audit engagement, including ability to upload files and documents;
Verifying Evidence module to record all test templates by users and process owners;
Creating final reports for Internal and External Audit Engagement;
Seeking management response for the said Internal and External Audit Engagement; and
Implementing the status of Internal and External Audit engagement, so as to increase transparency, reduce time & efforts associated with accessing the audit information.

15. A computer readable storage medium of claim 14 wherein the said test templates are set of checklists that can be filled up online or offline.

16. A computer readable storage medium of claim 14 wherein the process owners are added, deleted or changed at any stage in audit engagement.

17. A computer readable storage medium of claim 14 that stores the history trail of audit process, including tracking of test template and annexure.

18. A computer readable storage medium of claim 14 that allows integration of external auditors into the IA plan.
